(19) United States
(12) Patent Application Publication
(10) Pub. No.: US 2018/0324238 A1
(43) Pub. Date: Nov. 8, 2018

(54) A System and Methods Thereof for Auto-playing Video Content on Mobile Devices

(71) Applicant: ANIVIEW LTD., Tel Aviv (IL)

(72) Inventors: Tal Melenboim, Ashdod (IL); Itay Nave, Herzliya (IL)

(21) Appl. No.: 15/037,628

(22) PCT Filed: Feb. 17, 2016
(86) PCT No.: PCT/IB2016/050863

§ 371 Date: May 18, 2016

Related U.S. Application Data
(60) Provisional application No. 62/287,463, filed on Jan. 27, 2016.

(51) Int. Cl. H04L 29/06; H04N 21/462; H04N 21/472; H04N 21/234; G06F 17/30

(52) U.S. Cl. CPC H04L 65/607; H04N 21/4622; G06F 17/30817; H04N 21/234; H04N 21/47217

(57) ABSTRACT

A system is configured to auto-play video content item that comprises a plurality of frames on a web-page displayed on a mobile device. The system receives a request to auto-play the video content item on a display of the mobile device. The system fetches the video content item and metadata associated therewith. The system then parses the video content item into a plurality of files. Each of the plurality of files comprises a subset portion of the plurality of frames. The plurality of files are then sent to the mobile device for decoding by the mobile device to result in display of the video content item on the mobile device. A parallel decoding of the plurality of frames to a set of frames using multiple threads is then performed. A display schedule for displaying the set of frames on a display of the mobile device is generated. The set of frames is then drawn on a draw area and auto-played on the display of the mobile device.

This application claims the benefit of U.S. Provisional Application No. 62/287,463, filed on Jan. 27, 2016, the contents of which are herein incorporated by reference for all that it contains.

### TECHNICAL FIELD

The disclosure generally relates to systems for playing video content, and more specifically to system and methods for auto-playing video content items on mobile devices.

### DESCRIPTION OF THE BACKGROUND

The Internet, also referred to as the worldwide web (WWW), has become a mass media where the content presentation is largely supported by paid advertisements that are added to web-page content. Typically, advertisements displayed in a web-page contain video elements that are intended for display on the user's display device.

Mobile devices such as smartphones are equipped with mobile browsers through which users access the web. Such mobile browsers typically cannot display auto-played video clips on mobile web pages as the mobile HTML5 video component does not allow autoplay and requires user interaction such as clicking on the page in order to start the video playing. The term autoplay refers to starting playing a video on an HTML page when the page is loaded without requiring a user interaction such as clicking on the page. Furthermore, there are multiple video formats supported by different phone manufactures, which makes it difficult for the advertisers to know which phone the user has, and what video format to broadcast the video with.

JPEG format does not support animation, but using JavaScript to download a number of images and animate them is a widely used prior art. Most applications preload images all at once and use a JavaScript timer to playback the downloaded images.

Prior art solutions further introduced the idea of Animated GIF files where a number of “frames” are put together in a single file that could be played back at an interframe duration set in a file. Additionally, each frame could be used to update only a portion of the whole image to help in compression. This format, however, does not allow downloading images at a rate or bit encoding based on the observed network bandwidth. Furthermore, this format does not allow auto-playing of the frames as video content.

A video clip, inherently, and as is well known in the art, contains a plurality of frames also referred to as frame images. These frames have an inherent and predetermined timing depending on a frame rate. Prior art solutions disclose extraction of such frames from the video content, and displaying them using a predetermined, static frame-ticks table. The frame-ticks table is used for communicating the frame availability to the image playback process. However, in case a next frame is not available for display at its predetermined time, such frame shall be dropped, followed by the next frame, which shall be displayed only at its respective predetermined time. The quality of the display is therefore reduced. In cases where audio is provided simultaneously to the display of the video, such frame dropping affects he video-audio synchronization.

It would therefore be advantageous to provide a solution that would overcome the deficiencies of the prior art by enabling the display of video clips while avoiding wait time and video breaks.

### SUMMARY

As additional description to the embodiments described below, the present disclosure describes the following embodiments.

Embodiment 1 is a computer-implemented method for auto-playing a video content item in a web-page of a mobile device, wherein the video content item comprises a plurality of frames, the method comprises executing on a processor the steps of: receiving a request to auto-play the video content item in the web-page displayed on the mobile device; fetching the video content item and respective metadata; parsing the video content item into a plurality of files, wherein each of the plurality of files comprises a subset portion of the frames of the video content item, wherein the subset portion of the plurality of frames in each file of the plurality of files is encoded to be decoded in parallel by a plurality of threads on the mobile device; and, sending the plurality of files for decoding by the mobile device to result in display of the video content item on the mobile device.

Embodiment 2 is the computerized method of embodiment 1, wherein the mobile device is one of a group consisting of a smart phone, a mobile phone, a tablet computer, and a wearable computing device.

Embodiment 3 is the computerized method of embodiment 1, wherein the draw area is comprised of at least one of a group consisting of: canvas, GIF, and WEBGL.

Embodiment 4 is the computerized method of embodiment 1, wherein an audio play is initiated in parallel to playing the video.

Embodiment 5 is a computerized method of embodiment 1, further comprising identifying a type of the mobile device; and, generating a display schedule for auto-playing the set of frames as video content on the mobile device respective of the type of the mobile device.

Embodiment 6 is a non-transitory computer readable medium having stored thereon instructions for causing one or more processing units to execute a computer-implemented method for auto-playing a video content item in a web-page of a mobile device, wherein the video content item comprises a plurality of frames, the method comprises executing on a processor the steps of receiving a request to auto-play the video content item in the web-page displayed on the mobile device; fetching the video content item and respective metadata; parsing the video content item into a plurality of files, wherein each of the plurality of files comprises a subset portion of the frames of the video content item, wherein the subset portion of the plurality of frames in each file of the plurality of files is encoded to be decoded in parallel by a plurality of threads on the mobile device; and, sending the plurality of files for decoding by the mobile device to result in display of the video content item on the mobile device.

Embodiment 7 is a mobile device for auto-playing a video content item in a web-page, wherein the video content item comprises a plurality of frames, the mobile device comprising a display unit; a processing unit; and a memory coupled to the processing unit, the memory contains therein instructions that when executed by the processing unit configures the mobile device to fetch the video content as a plurality of files, wherein each of the plurality of files comprises a subset portion of the plurality of frames of the video content item; decode in parallel the plurality of files, using multiple threads, to a set of frames; generate a display schedule for displaying the set of frames on the display unit; draw the set of frames on a draw area respective of the at least one video content item; and auto-play the set of frames respective of the display schedule.

Embodiment 8 is the mobile device of embodiment 10, wherein the mobile device is one of a group consisting of a smart phone, a mobile phone, a tablet computer, and a wearable computing device.

Embodiment 9 is the mobile device of embodiment 10, wherein the metadata is at least one of a group consisting of container data, video data, audio data, and textual data

Embodiment 10 is the mobile device of embodiment 12, wherein the container data is at least one of a group consisting of a format, profile, commercial name of the format, duration, overall bit rate, writing application and library, title, author, director, album, and track number.

Embodiment 11 is the mobile device of embodiment 12, wherein the video data is at least one of a group consisting of a video format, codec identification data, aspect, frame rate, bit rate, color space, bit depth, scan type, and scan order.

Embodiment 12 is the mobile device of embodiment 12, wherein the audio data is at least one of a group consisting of audio format, audio codec identification data, sample rate, channels, language, and data bit rate.

Embodiment 13 is the mobile device of embodiment 12, wherein the textual data is at least one of a group consisting of textual format data, textual codec identification data, and language of subtitle.

### BRIEF DESCRIPTION OF THE DRAWINGS

The subject matter that is regarded as the disclosure is particularly pointed out and distinctly claimed in the claims at the conclusion of the specification. The foregoing and other objects, features and advantages of the disclosure will be apparent from the following detailed description taken in conjunction with the accompanying drawings.

FIG. 1—is a system for displaying video content on a display of a user device according to an embodiment.

FIG. 2—is a flowchart of the operation of a system for displaying video content on a display of a user device according to an embodiment.

FIG. 3—is a schematic diagram of an agent installed on the user device for displaying video content on a display unit of the user device.

FIG. 4—is a simulation of the operation of a system for displaying video content on a display of a user device according to an embodiment.

### DETAILED DESCRIPTION

The embodiments disclosed by the disclosure are only examples of the many possible advantageous uses and implementations of the innovative teachings presented herein. In general, statements made in the specification of the present application do not necessarily limit any of the various claimed disclosures. Moreover, some statements may apply to some inventive features but not to others. In general, unless otherwise indicated, singular elements may be in plural and vice versa with no loss of generality. In the drawings, like numerals refer to like parts through several views.

A system is configured to auto-play a video content item that comprises a plurality of frames on a web-page displayed on a mobile device. The system receives a request to auto-play the video content item on a display of the mobile device. The system fetches the video content item and metadata associated therewith. The system then parses the video content item into a plurality of files. In another exemplary embodiment, the system can further parse the video content item to a single file containing the collection of encoded frames. The term plurality of files refers herein to one or more files containing one or more sets of frames stored in the one or more files. Each of the plurality of files comprises a subset portion of the plurality of frames. The plurality of files can also be stored in a single file where each set of frames is stored in a portion of the file. The plurality of files are then sent to the mobile device. A parallel decoding of the plurality of frames to a set of frames using multiple threads is then performed. A display schedule for displaying the set of frames on a display of the mobile device is generated. The set of frames is then drawn on a draw area and auto-played on the display of the mobile device. In one exemplary embodiment, the draw area can be implemented using an HTML5 canvas. In another exemplary embodiment, the draw area may be implemented as an animated gif file. As yet another exemplary embodiment, the draw area can be implemented using webGL. As yet another exemplary embodiment, the draw area can be implemented using webRTC or any other means to draw an image on a display.

In order to render a video on a device with short delay time, as described in prior art, it is required to decode the video frames in real time. This process can be executed by a codec. The current disclosure discloses execution of a codec module in the context of the browser as part of the agent script that is included in the web page such as JavaScript. Such codec is responsible for generating frames out of the video file or files and the notion of a video codec that decodes the video in real-time as further described herein below.

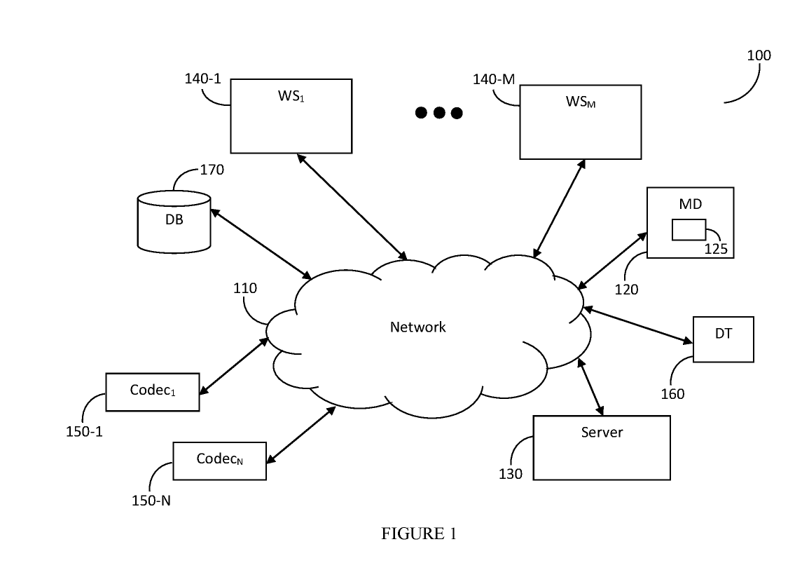

FIG. 1 depicts an exemplary and non-limiting diagram of a system 100 for displaying an auto-played video content item on a web-page display on a mobile device according to an embodiment. The system 100 comprises a network 110 that enables communications between various portions of the system 100. The network 110 may comprise the likes of busses, local area network (LAN), wide area network (WAN), metro area network (MAN), the worldwide web (WWW), the Internet, as well as a variety of other communication networks, whether wired or wireless, and in any combination, that enable the transfer of data between the different elements of the system 100. The system 100 further comprises a mobile device 120 connected to the network 110. The mobile device 110 may be, for example but without limitations, a smart phone, a mobile phone, a tablet computer, a wearable computing device and the like. The mobile device 120 comprises a display unit 125 such as a screen, a touch screen, etc.

A server 130 is further connected to the network 110. The system 100 further comprises one or more web sources 140-1 through 140-M (collectively referred hereinafter as web sources 140 or individually as a web source 140, merely for simplicity purposes), where M is an integer equal to or greater than 1. The web sources 140 may be web pages, websites, etc., accessible through the network 110. The web sources 140 may be operative by one or more publisher servers (not shown). The server 130 is configured to receive a request to display auto-played video content in a web-page displayed on the display unit 125 of the mobile device 120. According to one embodiment, the request may be received as a user's gesture over the display unit 125 of the mobile device 120. The request may be identified as part of an analysis by the server 130 of the web-page to be displayed on the mobile device 120. Auto-play videos, in web-pages such as hypertext markup language (HTML) etc., will automatically start playing as soon as it can do so without stopping. In mobile devices, the operating systems (OSs) typically cannot display such auto-play content in the context of an internet browser. According to another embodiment, the request may be received through an application program, such as an agent, installed on the mobile device 120.

Respective of the request, the server 130 is configured to fetch the at least one video content item from a web source, for example the web source 140-1. The request may include additional metadata that assists in the identification of a type of the at least one video content item.

According to an embodiment, the server 130 is further configured to identify a type of the mobile device 120 over which the at least one video content item is to be displayed. The type may include a configuration of the mobile device 120, an operating system (OS) of the device (e.g., Android®, iOS®, Windows®, etc.), a display size, a display type, a rendering capability of the mobile device 120, a number of processing units on the mobile device 120, a list of applications locally installed on the mobile device 120, and so on. The type of the mobile device 120 may further include a form factor of the mobile device 120 (e.g., a smartphone or a tablet device). According to the type and rendering capabilities of the mobile device 120, the server 130 determines what format of video to send thereto.

According to further embodiment, the server 130 is further configured to identify a type of the at least one video content item, i.e., the video file format (e.g., MP4, MOV, MPEG, M4V, etc.). The file type is identified by analyzing the metadata associated with the video content item. The metadata may include, for example, container data, video data, audio data, textual data and more. Container data may include, for example, a format, profile, commercial name of the format, duration, overall bit rate, writing application and library, title, author, director, album, track number, etc. Video data may include, for example, video format, codec identification data, aspect, frame rate, bit rate, color space, bit depth, scan type, scan order, etc. Audio data may include, for example, audio format, audio codec identification data, sample rate, channels, language, data bit rate, etc. Textual data may include, for example, textual format data, textual codec identification data, language of subtitle, etc.

The server 130 is then configured to select at least one codec of a plurality of codecs 150-1 through 150-N (collectively referred hereinafter as codecs 150 or individually as a codec 150, merely for simplicity purposes), where N is an integer equal to or greater than 1. The codec 150 is an electronic circuit or software that enables manipulation of video content such as, for example, compression and/or decompression of video content, conversion of video content to different file types, encoding and/or decoding of video content, etc. Different types of video content items require different codecs and therefore the selection of the appropriate codec is required in order to generate display video content on a variety of operating systems of mobile devices. Furthermore, the operation of the system 100 enables auto-play of the video content as the frames of the original video content are consequently displayed on the mobile device 120 as further described herein below. The selection of the codec to use may depend on the rendering and performance capabilities of the mobile device 120.

Following the selection of the at least one codec, for example, the codec 150-1, the server 130 initializes the codec 150-1 to encode the video content item to a plurality of frame ranges. The frame ranges can be stored in a plurality of files or in a single file. Each of the plurality of files comprises a subset portion of the frames of the video content items is in various encoding forms, for example, better portable graphics (BPG), MPEG-4 Part 14 (MP4), h265, etc. The plurality of files are encoded in a manner that they can be thereafter fetched and decoded in parallel by a plurality of threads on the mobile device 120. As a non-limiting example, in case the video content item is encoded to four frame ranges stored in four files, the files may be encoded as follows, so that the files can thereafter be sent to display on the mobile device 120 as soon as possible for decoding in parallel at the mobile device 120:

a. File1: Frames 1, 2, 3, 4, 5, 26, 27, 28, 29, 30, 51, 52, 53, 54, 55
b. File2: Frames 6, 7, 8, 9, 10, 31, 32, 33, 34, 35, 46, 47, 48, 49, 50
c. File3: Frames 11, 12, 13, 14, 15, 36, 37, 38, 39, 40, 41, 42, 43, 44, 45
d. File4: Frames 16, 17, 18, 19, 20, 21, 22, 23, 24, 25, 56, 57, 58, 59, 60

The files above allow four threads to decode frames on the mobile device 120 in parallel. In this example, when each thread decodes the first 5 frames, the first 20 frames of the video are ready to be rendered (e.g., because the combination of the first 5 frames from each threads totals the first 20 frames). The plurality of files are then sent by the server 130 to the mobile device 120. The system 100 further comprises a database 170. The database 170 is configured to store data related to the fetched video content, sets of frames, etc. According to another example, the frames may be ordered in one file at the following order:

a. File1: Frames 1, 2, 3, 4, 5, 26, 27, 28, 29, 30, 51, 52, 53, 54, 55, 6, 7, 8, 9, 10, 31, 32, 33, 34, 35, 46, 47, 48, 49, 50, 11, 12, 13, 14, 15, 36, 37, 38, 39, 40, 41, 42, 43, 44, 45, 16, 17, 18, 19, 20, 21, 22, 23, 24, 25, 56, 57, 58, 59, 60

Therefore, each set of frames can be sent to the client in response to a byte range request for the set of frame that will be handled by one of the multiple threads on the mobile device 120. Range 1 includes frames 1, 2, 3, 4, 5, 26, 27, 28, 29, 30, 51, 52, 53, 54, 55. Range 2 includes frames 6, 7, 8, 9, 10, 31, 32, 33, 34, 35, 46, 47, 48, 49, 50. Range 3 includes frames 11, 12, 13, 14, 15, 36, 37, 38, 39, 40, 41, 42, 43, 44, 45. Range 4 includes frames 16, 17, 18, 19, 20, 21, 22, 23, 24, 25, 56, 57, 58, 59, 60.

According to an embodiment, the multi-threading is implemented using web worker objects. A web worker is a JavaScript that runs in the background, independently of other scripts, without affecting the performance of the page. A web worker object may execute in its own context and share data with the main thread only using postMessage.

According to the disclosed embodiments, in order to reduce the use of postMessage, each web worker thread executes its associated set of frames as received from the server 130. Such execution is enabled by downloading specific frames as further described hereinabove or by using byte range calls to a single file holding all or part of the encoded frames. Subsequently to the files download, each web worker is decoding the frames and using postMessage to pass ownership of the decoded frame to the main thread.

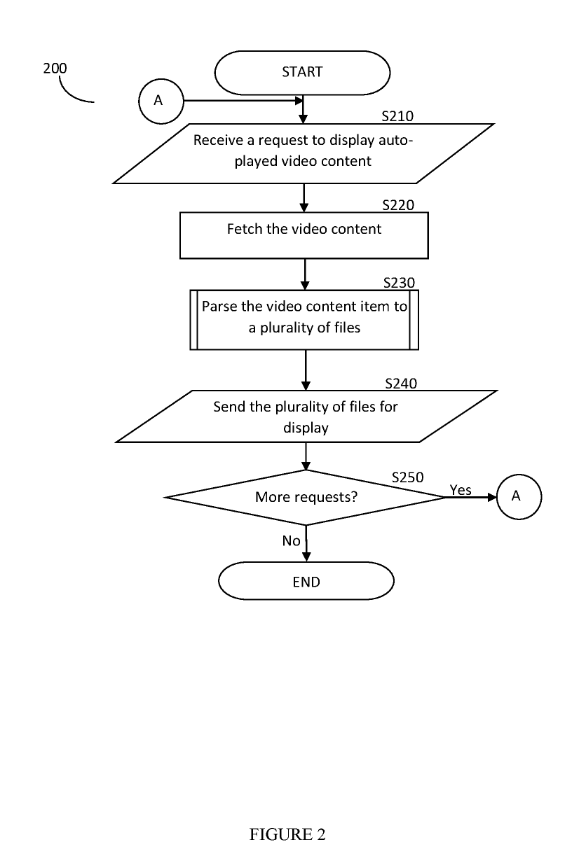

FIG. 2 is an exemplary and non-limiting flowchart 200 of the operation of displaying an auto-played video content on a display of a user device according to an embodiment. In S210, the operation starts when a request to display an auto-played video content item on the mobile device 120 is received, for example, by server 130. According to an embodiment, the request may be to stream video content to the mobile device 120.

In streaming, the video content item is delivered and displayed on the mobile device 120 through the web source 140. The verb “to stream” refers to a process of delivering the video content in this manner; the term refers to the delivery method of the medium, rather than the medium itself, and is an alternative to downloading.

In S220, the requested video content is fetched from a web source 140-1 through the network 110. The web source 140-1 is accessible by the server 130 over the network 110.

In S230, the requested video content is parsed to a plurality of files. According to an embodiment, the parsing may be performed by a codec, for example the codec 150-1. The codec 150-1 is initialized by the server 130 to decode the video content item to a set of frames.

In S240, the set of frames is then sent to a mobile device over the network 110, for example, split among multiple files to enable parallel decoding at the mobile device.

In S250, it is checked whether additional requests are received and if so, execution continues with S210; otherwise, execution terminates.

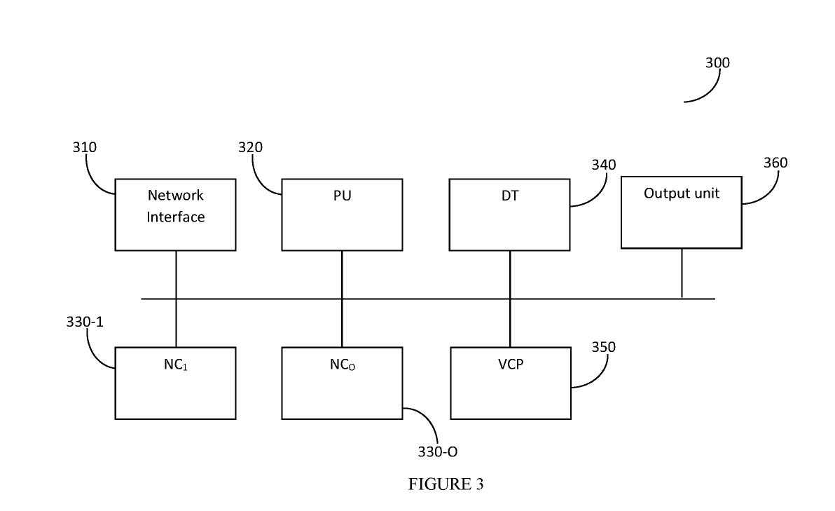

FIG. 3 depicts an exemplary and non-limiting schematic diagram of an agent 300 installed on the mobile device 120 for displaying auto-played video content that comprises a plurality of frames on a web-page displayed on the mobile device 120. The agent 300 is loaded when an HTML page is loaded. Upon page loading the agent 300 receives a request for displaying the auto-played video content on a web-page displayed on the mobile device 120, for example, as a result of user input. The agent 300 uses the interface 310 to fetch the video content item to be displayed on the display unit 125 of the mobile device 120. The video content item is received as a plurality of files, wherein each of the plurality of files comprises a subset portion of the plurality of frames of the video content item. In other words, each file may only include part of the frames of the video content item. Each of the files, however, may include groups of frames from multiple different portions of the video content item (e.g., one file may include the first 5 frames, then another 5 frames from later in the video content item, then another 5 frames from even later in the video content, with the missing frames between each group being stored in one or more other files. The files may be decoded by the mobile device in parallel. Decoding in parallel can mean that the all of the files are decoded at the same time, such that each of the files begins its decoding process for a certain number of frames before any of the files ends its decoding process of that same certain number of frames.

The agent 300 further comprises one or more processing units, that shall be referred to hereinafter as a processing unit (PU) 320 for the sake of simplicity. The PU 320 is configured to process the fetched video content item as a plurality of files. The agent 300 further comprises one or more native codecs 330-1 through 330-O (collectively referred hereinafter as native codecs 330 or individually as a native codec 330, merely for simplicity purposes). It should be noted that native in this respect does not refer to native code rather than to the codec script disclosed herein where O is an integer equal to or greater than 1. The native codec (NC) 330 is configured to decode in parallel the plurality of files using multiple threads to a set of frames. The agent 300 further comprises a drawing tool (DT) 340, the drawing tool 340 is configured to draw the set of frames on a draw area 350 (DA) respective of the video content item. The DA 350 can be implemented using an HTML5 canvas. In another exemplary embodiment, the draw area may be implemented as an animated gif file. As yet another exemplary embodiment, the draw area can be implemented using webGL or any other means to draw an image on a display. The processing unit 320 is further configured to generate a display schedule for displaying the set of frames as video content on the display unit 125. The agent 300 further comprises an output unit 360 for auto-playing the set of frames on the display unit 125 respective of display schedule.

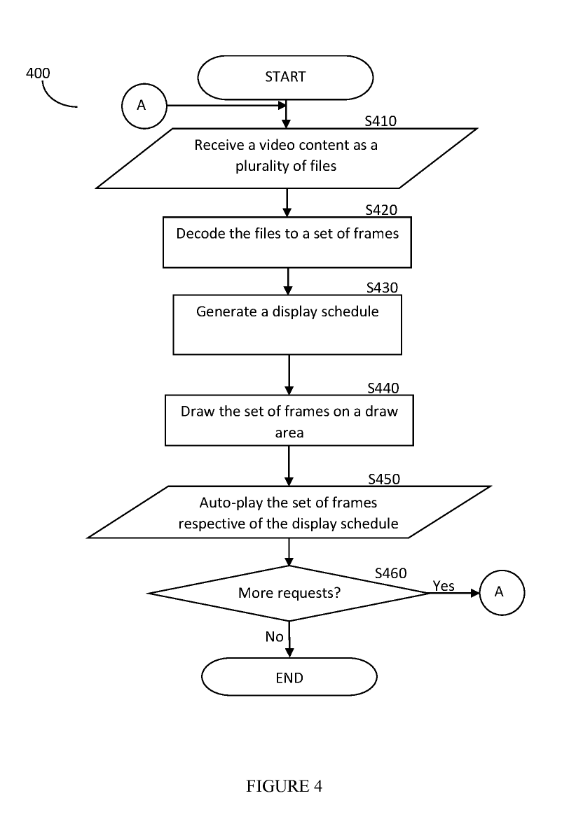

FIG. 4 depicts an exemplary and non-limiting flowchart 400 describing the operation of auto-playing a video content received as a plurality of files on a display of a mobile device according to an embodiment. In S410, the operation starts when at least one video content item is received as a plurality of files. Each file of the plurality of files comprises a subset portion of the plurality of frames of the video content item (e.g., multiple non-contiguous groups of frames from the video content item). According to an alternative embodiment, the plurality of files are fetched from a web source, for example, the web source 140-1. In S420, the plurality of files are decoded in parallel using multiple threads to generate a set of frames. In S430, a display schedule for displaying the set of frames on a display unit of the mobile device is generated. In S440, the set of frames is drawn on a draw area respective of the video content item. In S450, the set of frames is auto-played on the display unit respective of the display schedule. In S460, it is checked whether additional video content items have been received and if so, execution continues with S410; otherwise, execution terminates.

It should be clear for one of ordinary skill in the art that the operation of displaying an auto-played video content on a display of a user device according to an embodiment as described in FIG. 2, and the operation of auto-playing a video content received as a plurality of files on a display of a mobile device according to an embodiment as described in FIG. 4, can be integrated without departing from the scope of the disclosure.

The principles of the disclosure, wherever applicable, are implemented as hardware, firmware, software or any combination thereof. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program embodied in non-transitory computer readable medium, or any combination thereof, which may be executed by a CPU, whether or not such computer or processor is explicitly shown. Implementations may further include full or partial implementation as a cloud-based solution. In some embodiments, certain portions of a system may use mobile devices of a variety of kinds. In addition, various other peripheral units may be connected to the computer platform such as an additional data storage unit and a printing unit. The circuits described hereinabove may be implemented in a variety of manufacturing technologies well known in the industry including but not limited to integrated circuits (ICs) and discrete components that are mounted using surface mount technologies (SMT), and other technologies. The scope of the disclosure should not be viewed as limited by the SPPS 110 described herein and other monitors may be used to collect data from energy consuming sources without departing from the scope of the disclosure. The plurality of files are then sent by the server 130 to the mobile device 120.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A computer-implemented method for auto-playing a video content item in a web-page of a mobile device, wherein the video content item comprises a plurality of frames, the method comprises executing on a processor the steps of:
receiving a request to auto-play the video content item in the web-page displayed on the mobile device;
fetching the video content item and respective metadata;
parsing the video content item into a plurality of files, wherein each of the plurality of files comprises a subset portion of the frames of the video content item, wherein the subset portion of the plurality of frames in each file of the plurality of files is encoded to be decoded in parallel by a plurality of threads on the mobile device; and,
sending the plurality of files for decoding by the mobile device to result in display of the video content item on the mobile device.

2. The computerized method of claim 1, wherein the mobile device is one of a group consisting of a smart phone, a mobile phone, a tablet computer, and a wearable computing device.

3. The computerized method of claim 1, wherein the draw area is comprised of at least one of a group consisting of canvas, GIF, and WEBGL.

4. The computerized method of claim 1, wherein an audio play is initiated in parallel to playing the video.

5. The computerized method of claim 1, further comprising:
identifying a type of the mobile device; and,
generating a display schedule for auto-playing the set of frames as video content on the mobile device respective of the type of the mobile device.

6. A non-transitory computer readable medium having stored thereon instructions for causing one or more processing units to execute a computer-implemented method for auto-playing a video content item in a web-page of a mobile device, wherein the video content item comprises a plurality of frames, the method comprises executing on a processor the steps of:
receiving a request to auto-play the video content item in the web-page displayed on the mobile device;
fetching the video content item and respective metadata;
parsing the video content item into a plurality of files, wherein each of the plurality of files comprises a subset portion of the frames of the video content item, wherein the subset portion of the plurality of frames in each file of the plurality of files is encoded to be decoded in parallel by a plurality of threads on the mobile device; and,
sending the plurality of files for decoding by the mobile device to result in display of the video content item on the mobile device.

7. A mobile device for auto-playing a video content item in a web-page, wherein the video content item comprises a plurality of frames, the mobile device comprising:
a display unit;
a processing unit; and
a memory coupled to the processing unit, the memory contains therein instructions that when executed by the processing unit configures the mobile device to:
fetch the video content as a plurality of files, wherein each of the plurality of files comprises a subset portion of the plurality of frames of the video content item;
decode in parallel the plurality of files, using multiple threads, to a set of frames;
generate a display schedule for displaying the set of frames on the display unit;
draw the set of frames on a draw area respective of the at least one video content item; and
auto-play the set of frames respective of the display schedule.

8. The mobile device of claim 7, wherein the mobile device is one of a group consisting of a smart phone, a mobile phone, a tablet computer, and a wearable computing device.

9. The mobile device of claim 7, wherein the metadata is at least one of a group consisting of container data, video data, audio data, and textual data.

10. The mobile device of claim 9, wherein the container data is at least one of a group consisting of a format, profile, commercial name of the format, duration, overall bit rate, writing application and library, title, author, director, album, and track number.

11. The mobile device of claim 9, wherein the video data is at least one of a group consisting of a video format, codec identification data, aspect, frame rate, bit rate, color space, bit depth, scan type, and scan order.

12. The mobile device of claim 9, wherein the audio data is at least one of a group consisting of audio format, audio codec identification data, sample rate, channels, language, and data bit rate.

13. The mobile device of claim 9, wherein the textual data is at least one of a group consisting of textual format data, textual codec identification data, and language of subtitle.
